(19) United States
(12) Patent Application Publication
(10) Pub. No.: US 2016/0061340 A1
(43) Pub. Date: Mar. 3, 2016

(54) PNEUMATIC VALVE AND AIR MATTRESS ASSEMBLY HAVING PNEUMATIC VALVE

(71) Applicant: APEX MEDICAL CORP., New Taipei City (TW)

(72) Inventor: Wen Bin SHEN, New Taipei City (TW)

(21) Appl. No.: 14/471,720

(22) Filed: Aug. 28, 2014

(51) Int. Cl. F16K 15/20; F16K 47/04; A47C 27/08; F16K 31/16

(52) U.S. Cl. CPC F16K 15/205; F16K 31/16; F16K 47/04; A47C 27/081

(57) ABSTRACT

A pneumatic valve comprises a gas passage tube, a plug member, an elastic member and an adjustment member, wherein the gas passage tube is connected with the adjustment member and has a gas inlet and at least one first opening, the first opening being arranged between the gas inlet and the adjustment member; the plug member is disposed in the gas passage tube and has a blocking portion, the blocking portion having a first end proximal to the gas inlet and a second end distal from the gas inlet, the first end and the second end being located at two sides of the first opening respectively; and the elastic member is arranged between the plug member and the adjustment member.

### FIELD OF THE INVENTION

The present invention relates to a gas valve and more particularly to a pneumatic valve for pressure regulation of an air mattress.

### BACKGROUND OF THE INVENTION

Taiwan Patent No. M241551 discloses a relief valve, which has flow guide grooves formed on the conical body and a curved spring disposed in the connector, wherein the flow guide grooves may increase the gap between the conical body and the connector, and the curved spring may be oscillated and tilted by an angle by high pressure gas. The two structural designs are used to reduce collision frequency of gas molecules and reduce noise.

In addition, Taiwan Patent No. M426690 discloses a pressure regulation valve containing a connection tube received therein with a ball and a spring. The spring has a middle section with a diameter greater than two ends to reduce the gap between the spring and the inner wall of the connection tube, thereby reducing oscillation of the spring and inhibiting noise. The spherical ball allows stable passage of gas through the inlet to perform pressure regulation and to prevent unstable gas pressure within the pressure equipment.

Although various designs have been proposed to reduce noise, they are not satisfactory at least in some aspects.

### SUMMARY OF THE INVENTION

A primary objective of this invention is to provide a pneumatic valve with reduced noise during operation.

To achieve the aforesaid objective, this invention provides a pneumatic valve comprising a gas passage tube, a plug member, an elastic member and an adjustment member, wherein the gas passage tube is connected with the adjustment member and has a gas inlet and at least one first opening, the first opening being arranged between the gas inlet and the adjustment member; the plug member is disposed in the gas passage tube and has a blocking portion, the blocking portion having a first end proximal to the gas inlet and a second end distal from the gas inlet, the first end and the second end being located at two different sides of the first opening respectively; and the elastic member is arranged between the plug member and the adjustment member.

This invention further provides a pneumatic valve comprising a gas passage tube, a plug member, an elastic member and an adjustment member, wherein the gas passage tube is connected with the adjustment member and has a gas inlet and at least one first opening, the first opening being arranged between the gas inlet and the adjustment member; the plug member is disposed in the gas passage tube and has a blocking portion, the blocking portion having a first end proximal to the gas inlet and a second end distal from the gas inlet; and wherein the plug member is switchable between a deflation state and a non-deflation state in such a way that the plug member has a portion with the greatest width arranged between the first opening and the elastic member in both states.

Moreover, this invention provides an air mattress assembly comprising: an air mattress body comprising a plurality of air tubes; at least one pneumatic valve recited above in gas communication with at least one of the air tubes; and a manipulation unit having a rotary knob configured for controlling pressure regulation of the air mattress body, the rotary knob being operably linked to the adjustment member of the pneumatic valve to allow adjustment of a force imposed by the elastic member on the plug member.

Using the structural design of the plug member and the positional relationship between the plug member and the first opening, as described above, in the presence of high pressure gas, the first end of the blocking portion of the plug member is pushed and moved inwardly, such that the high pressure gas passing through the gas inlet may enter the gas passage tube from the gap formed between the blocking portion of the plug member and the inner wall of the gas passage tube and leave the valve from the first opening. Since the second end of the blocking portion of the plug member is arranged at one side of the first opening opposite to the gas inlet, it occupies a part of, if not all, the space of the passage defined in the gas passage tube, and high pressure gas is prevented from passing through the second end of the blocking portion of the plug member and forming turbulence or oscillating the elastic member and the adjustment member, thereby reducing the noise caused by oscillation of the components as well as the noise caused by gas turbulence.

A main feature of this invention lies in that, in both the deflation state and the non-deflation or ordinary state, at one side of the first opening opposite to the gas inlet, the passage defined in the gas passage tube is substantially blocked or occupied by the plug member, thereby inhibiting gas passage therethrough and noise resulted therefrom.

It is to be understood that both the foregoing general description and the following detailed description are exemplary and explanatory only and are not restrictive of the invention as defined in the claims.

### BRIEF DESCRIPTION OF THE DRAWINGS

A more complete understanding of the subject matter can be derived by referring to the detailed description and claims when considered in conjunction with the following figures, wherein like reference numbers refer to similar elements throughout the figures.

FIG. 1 illustrates an exploded view showing an exemplary embodiment of the pneumatic valve according to this invention;

FIG. 2 illustrates a cross-sectional view showing an exemplary embodiment of the pneumatic valve according to this invention in an ordinary or non-deflation state;

FIG. 3 illustrates a cross-sectional view showing an exemplary embodiment of the pneumatic valve according to this invention in a deflation state; and

FIG. 4 illustrates a schematic view showing an exemplary embodiment of the air mattress assembly according to this invention.

### DETAILED DESCRIPTION OF THE INVENTION

In order to further explain the concepts and principles behind this invention, the operational states and structural configuration of various embodiments are described with the accompanying drawings. However, there is no intention to be bound by any expressed or implied theory presented in the preceding technical field, background, brief summary or the following detailed description.

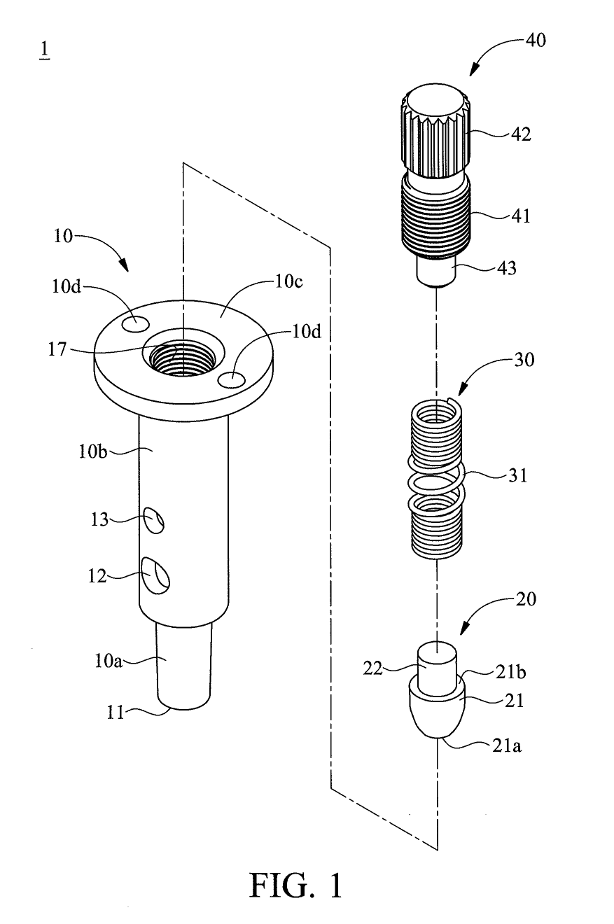

FIG. 1 illustrates an exploded view showing an embodiment of the pneumatic valve according to the present invention. In this embodiment, pneumatic valve 1 mainly comprises a gas passage tube 10, a plug member 20, an elastic member 30 and an adjustment member 40. The plug member 20 is received in the gas passage tube 10, and the elastic member 30 has one end elastically pushing the plug member 20 and the other end supported by the adjustment member 40, which is adjustably connected with the gas passage tube 10.

To more concisely describe the size and spatial relationship between different components, the term “width” is defined hereinafter as the maximum length of a cross-section obtained from a direction perpendicular to the longitudinal direction of the gas passage tube 10. Generally, “width” and “cross-section” are synonyms to each other and interchangeably used. For a component with a cylindrical or similar shape, the width of the component or a part thereof refers to the diameter of its cross-section.

The gas passage tube 10 has a hollow tubular structure similar to a syringe. It defines an accommodation space therein for receiving other components, such as the plug member 20 and the elastic member 30. Thread 17 is formed on the inner wall at one end for corresponding connection with the adjustment member 40. Depending on the need for installation or use, the gas passage tube 10 may be optionally provided with a securing ring 10c, on which mounting holes 10d are formed to allow the gas passage tube 10 to be mounted by screws in a use environment or connected and operated with other components in the use environment. As illustrated in FIG. 1, in one embodiment, the hollow tubular structure of the gas passage tube 10 may consist of a first tubular section 10a and a second tubular section 10b, connected with each other or integrally formed, each individually having an internal space and a shape that may be the same or different. For example, the first tubular section 10a may define therein a first space as the gas channel, such that gas may enter the gas passage tube 10 from the gas inlet 11 at one end of the first tubular section 10a, and the second tubular section 10b may define therein a second space as the accommodation space for the components. Moreover, the second tubular section 10b is provided with at least one opening on its tubular wall, such as the first opening(s) 12 and second opening(s) 13 as the major and minor gas relief holes respectively. Detailed descriptions of the gas flow path and operational configuration of the components are given below in conjunction with the cross-sectional views of the embodiments.

The plug member 20 is disposed in the gas passage tube 10, such as with one end pushed by the elastic member 30 and therefore situated at a border between the first space and the second space. The plug member 20 has a blocking portion 21 for sealing the first space. In the presence of high pressure gas, the blocking portion 21 is pushed and moved toward the elastic member 30, such that high pressure gas can pass through the gap between the blocking portion 21 and the inner wall of the gas passage tube 10 and then be discharged from the first opening 12. To seal the first space, the blocking portion 21 may have a bullet-like structure as shown in FIG. 1, such as half of a prolate spheroidal or oval structure, having a first end 21a and a second end 21b. As used herein, unless otherwise specified, the term “end” refers to the endmost or terminal portion of a structure, which may be a point, a plane, or a structural region, depending on the geometric shape of the structure referred to. For example, in FIG. 1, the first end 21a of the blocking portion 21 is the protruded tip portion of the bullet-like structure, and the second end 21b of the blocking portion 21 is the flat bottom of the bullet-like structure. In order to improve the sealing effect, the first end 21a of the blocking portion 21 may extend into the first space, such that the inner wall of the first tubular section 10a and the circumferential surface of the blocking portion 21 form airtight or sealed connection to prevent gas from passing through the plug member 20 and being discharged from the first opening 12 in the non-deflation state. The second end 21b of the blocking portion 21 may be a circular flat plane arranged in the second space and preferably have a cross-section greater than other portions of the blocking portion 21, such as approximately equal to or slightly less than the cross-section defined by the corresponding inner wall of the gas passage tube 10, so as to minimize or inhibit gas passage through the second end 21b of the blocking portion 21 and noise resulted therefrom. In order to firmly connect the plug member 20 and the elastic member 30, the plug member 20 may have a connection portion 22, such as a cylindrical structure with a diameter slightly greater than the inner diameter of one end of the elastic member 30, rendering the plug member 20 as a mushroom-like structure and fittingly and tightly combining the elastic member 30 with the plug member 20. As used herein, unless otherwise specified, “fittingly and tightly combine” or analogous expression refers to two structures combined and fit together tightly and firmly. Generally, a force is required to deform one structure to fittingly and tightly combine it with the other structure. For example, an elastic structure needs to be stretched or compressed to fittingly and tightly combine it with other structures.

The elastic member 30 may be an elongated spring structure, with one end abutting against the plug member 20 and the other end abutting against the adjustment member 40. In one embodiment, two ends of the elastic member 30 are respectively fittingly and tightly sleeved on the connection portion 22 of the plug member 20 and the connection portion 43 of the adjustment member 40. The elastic member 30 is disposed in the gas passage tube 10, such as in the accommodation space defined by the second tubular section 10b. The elastic member 30 serves to elastically push the plug member 20, such that the plug member 20 can tightly seal the gas channel in the gas passage tube 10, preventing gas from being discharged from the opening on the gas passage tube 10. According to the above-mentioned structural design, only when the pressure of the high pressure gas is greater than the elastic pushing force of the elastic member 30, will the plug member 20 be pushed and moved toward the elastic member 30, thereby allowing gas to pass through the gap between the plug member 20 and the inner wall of the gas passage tube 10 and leave from the first openings 12. In one embodiment, the middle section 31 of the elastic member 30 may have a width greater than that of other sections, such that the gap between the elastic member 30 and the inner wall of the gas passage tube 10 may be narrowed to minimize the oscillation of the elastic member 30 and reduce the noise resulted therefrom.

The adjustment member 40 is generally connected with the terminal of the gas passage tube 10, serving to abut and support the elastic member 30 and make the elastic member 30 press against the plug member 20. The adjustment member 40 may have a thread 41, an engagement section 42 and a connection portion 43. The thread 41 is engageable with the thread 17 of the gas passage tube 10 correspondingly, to enable users to rotatably adjust the engagement tightness or depth between the adjustment member 40 and the gas passage tube 10, so as to adjust the elastic force of the elastic member 30 on the plug member 20. The connection portion 43 may have a shape and a size similar to the connection portion 22 of the plug member 20 and may also be fittingly and tightly sleeved by the elastic member 30. A plurality of teeth are formed on the engagement section 42 to mesh and operably link to external components, by which users may adjust the relative relationship between the adjustment member 40 and the gas passage tube 10 so as to modify the pushing force of the elastic member 30 against the plug member 20.

The advantageous features, structural designs and operational configurations of this invention are further elaborated below by referring to the cross-sectional views of one embodiment of this invention.

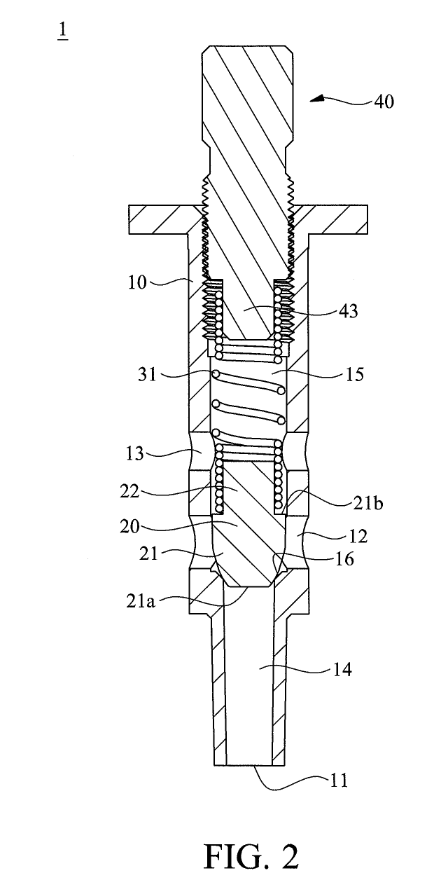

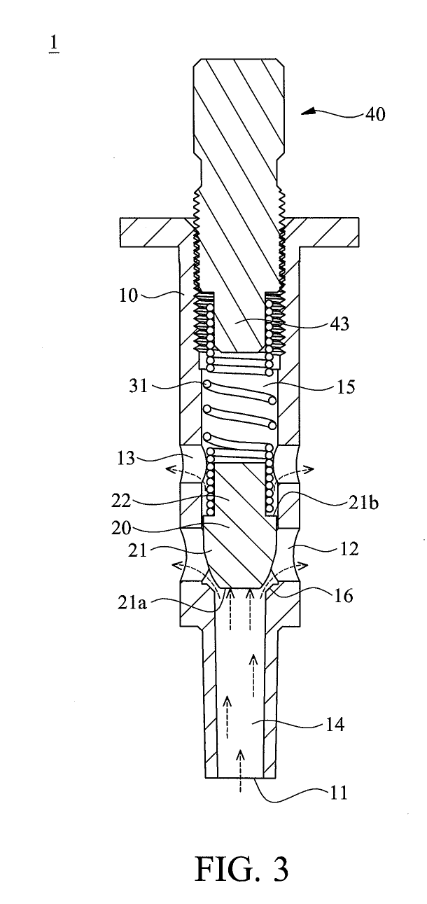

FIGS. 2 and 3 respectively illustrate the spatial configurations of different components in an ordinary state and a deflation state. In the ordinary or non-deflation state, there is no high pressure gas entering the pneumatic valve 1 from the gas inlet 11, or the pressure of the high pressure gas is less than the elastic force of the elastic member 30 set by users through the adjustment member 40, so the blocking portion 21 of the plug member 20 is airtightly situated and secured in the hollow channel in the gas passage tube 10 and airtightly connected with the inner wall of the gas passage tube 10. In order to secure the plug member 20 in the hollow channel in the gas passage tube 10, such as between the first space 14 and the second space 15, an obstruction structure 16, such as a protrusion or other similar structures, can be formed on the inner wall of the gas passage tube 10, and the plug member 20 may be positioned within the gas passage tube 10 at a predetermined position by the elastic member 30 and the obstruction structure 16. In this embodiment, the curved inner wall at the border between the first space 14 and the second space 15 serves as the obstruction structure 16.

As described above, the gas passage tube 10 may define therein the first space 14 and the second space 15, wherein the first space 14 serves as the gas channel for introducing gas from the gas inlet 11 into the gas passage tube 10, and the second space 15 serves as the accommodation space for receiving the components. In this embodiment, the first space 14 is a gas channel gradually expanded from the gas inlet 11 inwardly, which serves as a flow guide to allow the high pressure gas to gently and smoothly push the plug member 20 to inwardly compress the elastic member 30, thereby providing a gentle and moderate gas deflation effect, avoiding abrupt gas deflation, and prolonging the service life of the components such as the plug member 20, the elastic member 30, etc.

In this embodiment, the blocking portion 21 of the plug member 20 has a first end 21a and a second end 21b, wherein the first end 21a has gas-modulating means, such as a flat surface, a concave surface or a convex surface. When the high pressure gas enters the gas passage tube 10 from the gas inlet 11, the gas-modulating means enables a substantial part of the high pressure gas to act on the plug member 20 in a direction substantially perpendicular to the first end 21a, thereby making the gas act on the plug member 20 with a normal force greater than a shear stress. As an example, the gas-modulating means may be implemented by configuring the first end 21a as a blunt end, such as the flat plane shown in FIG. 2. The gas-modulating means provides several advantages as described below. When the plug member 20 is pushed and moved inwardly by the high pressure gas, said flat plane and the inner wall of the gas passage tube 10 define a gap therebetween greater than the one formed using a spherical or conical structural design with the same displacement or movement amount, therefore providing a greater deflation efficiency per time unit than other shapes. In addition, if the first end 21a of the blocking portion 21 is configured as a flat plane perpendicular to the gas channel of the first space 14, when the high pressure gas enters the first space 14, most gas molecules impact the plug member 20 in a direction perpendicular to the flat plane; therefore, under the same flow amount or pneumatic pressure, said structural design results in a greater displacement amount of the plug member 20 than other shapes and consequently forms a larger gap between the plug member 20 and the inner wall of the gas passage tube 10, thereby increasing the deflation efficiency. Moreover, the flat plane design may divert the high pressure gas by a large extent, avoiding the high pressure gas from further moving into the gas passage tube 10 and discharging the gas from the gas relief holes at two sides, thereby inhibiting the high pressure gas from passing through the plug member 20 and causing oscillation of the components in the gas passage tube 10 and forming turbulence.

In this embodiment, the size of each component may be designed as described below, wherein the term “width” is defined as recited above as the maximum length of a cross-section obtained from a direction perpendicular to the longitudinal direction of the gas passage tube 10. For a circular cross-section, the width represents its diameter.

One side of the first space 14 close to the gas inlet 11 has a width less than that of the other side, and the first end 21a of the blocking portion 21 has a width slightly less than that of one side of the first space 14 distal from the gas inlet 11, such that the blocking portion 21 may partially extend into the first space 14. The second end 21b of the blocking portion 21 has a width greater than other portions of the blocking portion 21 and substantially equal to or slightly less than the inner diameter of the corresponding portion of the gas passage tube 10, such that there is nearly no gap between the inner wall of the gas passage tube 10 and the second end 21b of the blocking portion 21, which may reduce the noise caused by the collision between the plug member 20 and the gas passage tube 10 due to oscillation on one hand, and on the other hand prevent the high pressure gas from passing through the plug member 20 and generating noise due to turbulence formation or oscillation of the elastic member 30. In addition, in this embodiment, the first end 21a and the second end 21b of the blocking portion 21 are respectively arranged at different sides of the first opening 12. In other words, as illustrate in FIG. 2, in the non-deflation state, the first end 21a and the second end 21b of the blocking portion 21 are both situated out of the first opening 12 and are located below and above the first opening 12 respectively. For example, the position of the first end 21a is slightly lower than the first opening 12 to seal the first space 14, and the position of the second end 21b is slightly higher than the first opening 12 to prevent gas passage therethrough, as described in detail below.

The inner diameters or widths of two end portions of the elastic member 30 are both slightly less than those of the connection portion 22 of the plug member 20 and the connection portion 43 of the adjustment member 40. Therefore, by stretching the elastic member 30 and sleeving it on the connection portion 22 and the connection portion 43, the elastic member 30 may be fittingly and tightly combined with the plug member 20 and the adjustment member 40, so as to prevent the noise caused by oscillation of these components and firmly secure the elastic member 30 even after repeated use. In addition, the middle section 31 of the elastic member 30 has a width substantially equal to or slightly less than the inner diameter of the corresponding portion of the gas passage tube 10, such that there is nearly no gap between the inner wall of the gas passage tube 10 and the middle section 31 of the elastic member 30, thereby reducing the noise caused by the collision between the elastic member 30 and the gas passage tube 10 due to oscillation. However, in view of the friction between the components during operation, the width of the second end 21b of the blocking portion 21 and the width of the middle section 31 of the elastic member 30 may be slightly less than the inner diameter of the corresponding portions of the gas passage tube 10 so as to prevent friction between the components or unsmooth operation and prolong the service life of the components.

FIG. 3 illustrates the cross-sectional view of the pneumatic valve 1 in the presence of high pressure gas, which is denoted by broken lines and arrows. In the deflation state, the high pressure gas flows from the air mattress into the gas inlet 11 and enters the first space 14 to push the plug member 20. If the pneumatic pressure is greater than the elastic force imposed on the plug member 20 by the elastic member 30, the plug member 20 will be pushed by the high pressure gas and moved inwardly, such that a gap is formed between the plug member 20 and the inner wall of the gas passage tube 10, and the gas may pass through the plug member 20 and leave or be deflated from the gas relief holes, such as the first openings 12, thereby achieving the purpose of deflation.

In this embodiment, the gas passage tube 10 is configured thereon with two first openings 12, which are arranged symmetrically about the longitudinal direction of the gas passage tube 10, such that the gas may be deflated from both first openings 12 by the substantially same flow rate. In addition, in this embodiment, because the second end 21b of the blocking portion 21 has a width greater than that of the first end 21a and there is nearly no or minimal gap between the second end 21b of the blocking portion 21 and the inner wall of the gas passage tube 10, most of the gas will change the direction after impacting the first end 21a of the blocking portion 21 and then leave from the first openings 12. However, on rare occasions, there may be a small amount of gas passing through the second end 21b of the blocking portion 21. In this situation, if too much high pressure gas accumulates in the space above the plug member 20, a pneumatic pressure will be formed in the space which downwardly pushes the plug member 20 and results in a poor deflation effect. In this regard, the gas passage tube 10 can be further configured with second openings 13 as the minor gas relief holes on the tubular wall above the first openings 12, so as to discharge the gas not deflated from the first openings 12 and passing through the blocking portion 21. In this embodiment, the quantity and size of the second openings 13 are not particularly limited, but two second openings 13 may be adopted; in addition, the second openings 13 may also be arranged symmetrically about the longitudinal direction of the gas passage tube 10.

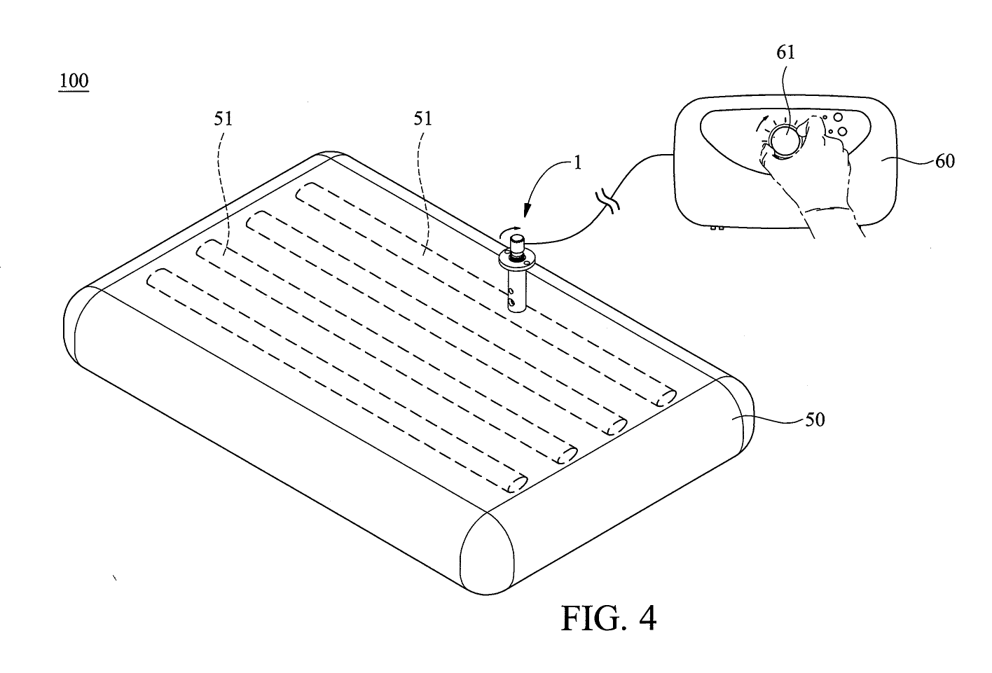

The use environment of the pneumatic valve 1 according to one embodiment of this invention is illustrated below. As shown in FIG. 4, the pneumatic valve 1 may be used in an air mattress assembly 100, which further comprises an air mattress body 50 and a manipulation unit 60, wherein the pneumatic valve 1 is in gas communication with at least one air tube 51 of the air mattress body 50. Therefore, during the deflation of the air mattress body 50, high pressure gas in the air tube 51 may enter the pneumatic valve 1 through the gas inlet 11 to initiate the foregoing deflation process. In addition, the pneumatic valve 1 may be linked or coupled to the rotary knob 61 of the manipulation unit 60 via the engagement section 42 of the adjustment member 40, thereby allowing a user to adjust the elastic force of the elastic member 30 in the pneumatic valve 1 by rotating the rotary knob 61. Generally, the installation position of the pneumatic valve 1 is not particularly limited, and it may be installed in the air mattress body 50 or in the manipulation unit 60, such as being fastened in the rotary knob 61 through the mounting holes 10d. In addition, the operational linkage between the adjustment member 40 of the pneumatic valve 1 and the rotary knob 61 may vary as needed to provide users with convenience in use. For example, an equal rotation angle relationship can be employed, such that when a user rotates the rotary knob 61 by such as 10 degrees, the adjustment member 40 may similarly rotates by 10 degrees; alternatively, a proportional rotation relationship can be employed, such that when a user rotates the rotary knob 61 by such as 10 degrees, the adjustment member 40 correspondingly rotates 1, 2 or 5 degrees, thereby allowing the user to fine-tune or precisely adjust the pneumatic valve 1; alternatively, a stagewise rotation relationship can be employed, such that when a user rotates the rotary knob 61 by 0 to 10 degrees, the adjustment member 40 does not rotate correspondingly, and when the user rotates the rotary knob 61 by 10 to 20 degrees, the adjustment member 40 rotates correspondingly by 1, 2 or 5 degrees. Detailed illustrations for achieving the operational linkage for various rotation relationships are omitted for brevity as they are conceivable by a person skilled in the art without undue experimentation.

The above detailed description is merely illustrative in nature and is not intended to limit the embodiments of the subject matter or the application and uses of such embodiments. As used herein, the term “exemplary” means “serving as an example, instance, or illustration.” Any implementation described herein as exemplary is not necessarily to be construed as preferred or advantageous over other implementations.

Moreover, while at least one exemplary embodiment has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and foreseeable equivalents at the time of filing this patent application.

What is claimed is:

1. A pneumatic valve, comprising a gas passage tube, a plug member, an elastic member and an adjustment member, wherein the gas passage tube is connected with the adjustment member and has a gas inlet and at least one first opening, the first opening being arranged between the gas inlet and the adjustment member; the plug member is disposed in the gas passage tube and has a blocking portion, the blocking portion having a first end proximal to the gas inlet and a second end distal from the gas inlet, the first end and the second end being located at two sides of the first opening respectively; and the elastic member is arranged between the plug member and the adjustment member.

2. The pneumatic valve of claim 1, wherein the gas passage tube further comprises at least one second opening arranged between the first opening and the adjustment member.

3. The pneumatic valve of claim 2, wherein the gas passage tube comprises two first openings and two second openings respectively arranged symmetrically about a longitudinal direction of the gas passage tube.

4. The pneumatic valve of claim 1, wherein the first end of the blocking portion is provided with gas-modulating means for enabling gas entering the gas passage tube from the gas inlet to act on the plug member with a normal force greater than a shear stress.

5. The pneumatic valve of claim 1, wherein the first end of the blocking portion is a blunt end.

6. The pneumatic valve of claim 5, wherein the blunt end has a flat plane.

7. The pneumatic valve of claim 1, wherein the gas passage tube defines a first space and a second space therein, and the first space is a gas channel gradually expanded from the gas inlet inwardly.

8. The pneumatic valve of claim 7, wherein the first end and the second end of the blocking portion are respectively disposed in the first space and the second space.

9. The pneumatic valve of claim 7, wherein the gas passage tube comprises an obstruction structure formed at a border between the first space and the second space, the obstruction structure and the elastic member collectively positioning the plug member in the gas passage tube.

10. A pneumatic valve, comprising a gas passage tube, a plug member, an elastic member and an adjustment member, wherein the gas passage tube is connected with the adjustment member and has a gas inlet and at least one first opening, the first opening being arranged between the gas inlet and the adjustment member; the plug member is disposed in the gas passage tube and has a blocking portion, the blocking portion having a first end proximal to the gas inlet and a second end distal from the gas inlet; and wherein the plug member is switchable between a deflation state and a non-deflation state in such a way that the plug member has a portion with the greatest width arranged between the first opening and the elastic member in both states.

11. The pneumatic valve of claim 10, wherein the gas passage tube defines a first space and a second space therein, the first space being a gas channel gradually expanded from the gas inlet inwardly and the second space being an accommodation space receiving the plug member and the elastic member.

12. The pneumatic valve of claim 11, wherein the gas passage tube comprises an obstruction structure formed at a border between the first space and the second space, the obstruction structure and the elastic member collectively positioning the plug member in the gas passage tube.

13. The pneumatic valve of claim 10, wherein the gas passage tube further comprises at least one second opening arranged between the first opening and the adjustment member, and a portion of the blocking portion with the greatest width is located between the first opening and the second opening.

14. An air mattress assembly, comprising:
an air mattress body comprising a plurality of air tubes;
at least one pneumatic valve recited in claim 1 in gas communication with at least one of the air tubes; and
a manipulation unit having a rotary knob configured for controlling pressure regulation of the air mattress body, the rotary knob being operably linked to the adjustment member of the pneumatic valve to allow adjustment of a force imposed by the elastic member on the plug member.

15. The air mattress assembly of claim 14, wherein the rotary knob is operably linked to the adjustment member of the pneumatic valve in a proportional rotation relationship such that the adjustment member is rotatable by a smaller angle when the rotary knob is rotated.
